(19) United States
(12) Patent Application Publication
(10) Pub. No.: US 2026/0330974 A1
(43) Pub. Date: Oct. 22, 2026

(54) LEARNING DEVICE AND LEARNING METHOD

(71) Applicant: TOYOTA JIDOSHA KABUSHIKI KAISHA, Toyota-shi (JP)

(72) Inventors: Ryuji Okamura, Gotemba-shi (JP); Takahiro Yokota, Susono-shi (JP); Yuki Okamoto, Ebina-shi (JP); Amane Yajima, Ashigarakami-gun (JP); Kazuki Egashira, Susono-shi (JP); Yuhei Oka, Susono-shi (JP); Kento Iwahori, Nagoya-shi (JP)

(73) Assignee: TOYOTA JIDOSHA KABUSHIKI KAISHA, Toyota-shi (JP)

(21) Appl. No.: 19/468,698

(22) Filed: Feb. 3, 2026

(30) Foreign Application Priority Data
Mar. 6, 2025 (JP) 2025-035477

(51) Int. Cl. G08G 1/16; G06N 20/00; H04W 4/46

(52) U.S. Cl. CPC G08G 1/161; G06N 20/00; H04W 4/46

(57) ABSTRACT

A learning device includes an acquisition unit that acquires a detection result of a mobility environment detected by a preceding moving object from among a plurality of moving objects that moves along a route that is set in advance, a learning unit that updates a trained model using the detection result, and a transmission unit that transmits the trained model that is updated to a trailing moving object, from among the moving objects, that moves along the route after the preceding moving object.

### CROSS-REFERENCE TO RELATED APPLICATION

This application claims priority to Japanese Patent Application No. 2025-035477 filed on Mar. 6, 2025. The disclosure of the above-identified application, including the specification, drawings, and claims, is incorporated by reference herein in its entirety.

### BACKGROUND

### 1. Technical Field

The present disclosure relates to a learning device and a learning method.

### 2. Description of Related Art

There is known technology for causing a vehicle to travel by autonomous control, during a vehicle manufacturing process (e.g., Japanese Unexamined Patent Application Publication (Translation of PCT Application) No. 2017-538619 (JP 2017-538619 A)).

### SUMMARY

A moving object such as a vehicle or the like acquires its own position using, for example, detection results of a mobility environment by sensors such as in-vehicle cameras and so forth, and a trained model that has learned the mobility environment, and moves to a destination under autonomous control based on its own position. However, change occurring in the mobility environment may make acquisition of the own position unattainable.

The present disclosure can be realized as the following aspects.

(1) According to a first aspect of the present disclosure, there is provided a learning device. This learning device includes an acquisition unit that acquires a detection result of a mobility environment detected by a preceding moving object from among a plurality of moving objects that moves along a route that is set in advance, a learning unit that updates a trained model using the detection result, and a transmission unit that transmits the trained model that is updated to a trailing moving object, from among the moving objects, that moves along the route after the preceding moving object.

According to the learning device of this aspect, even when change occurs in the mobility environment, the trained model can be updated using the detection results of the mobility environment acquired from the preceding moving object, and the trained model that is updated can be transmitted to the trailing moving object. Accordingly, the trailing moving object can acquire its own position using the trained model that is updated and the detection results of the mobility environment.

(2) In the learning device according to the aspect described above, when an event that is set in advance occurs, the learning unit may update the trained model using the detection result acquired from the preceding moving object that moved along the route after occurrence of the event.

According to the learning device of this aspect, the trained model can be updated at an appropriate timing.

(3) In the learning device according to the aspect described above, when a period of time that is set in advance elapses, the learning unit may update the trained model using the detection result acquired from the preceding moving object that moved along the route within the period of time.

According to the learning device of this aspect, decrease in precision of position estimation using the trained model, when the mobility environment changes gradually, can be suppressed.

(4) In the learning device according to the aspect described above, the preceding moving object may be configured to detect the mobility environment in more detail than the trailing moving object.

According to the learning device of this aspect, the precision of position estimation using the trained model can be improved.

(5) In the learning device according to the aspect described above, the moving objects may include a plurality of first-type moving objects and a plurality of second-type moving objects of a different type from the first-type moving objects, the learning device further may include a classification unit that classifies a first detection result that is a detection result acquired from a first-type preceding moving object from among the first-type moving objects, and a second detection result that is a detection result acquired from a second-type preceding moving object from among the second-type moving objects, the learning unit may update a first trained model using the first detection result, and update a second trained model using the second detection result, and the transmission unit may transmit the first trained model that is updated to a first-type trailing moving object from among the first-type moving objects that moves along the route after the first-type preceding moving object, and transmit the second trained model that is updated to a second-type trailing moving object from among the second-type moving objects that moves along the route after the second-type preceding moving object.

According to the learning device of this aspect, the trained model can be updated for each type of moving object, and the updated trained model can be transmitted to the moving body for each type of moving object.

(6) According to a second aspect of the present disclosure, there is provided a learning method. This learning method includes acquiring a detection result of a mobility environment detected by a preceding moving object from among a plurality of moving objects that moves along a route that is set in advance, updating a trained model using the detection result, and transmitting the trained model that is updated to a trailing moving object, from among the moving objects, that moves along the route after the preceding moving object.

According to the learning method of this aspect, even when change occurs in the mobility environment, the trained model can be updated using the detection results of the mobility environment acquired from the preceding moving object, and the trained model that is updated can be transmitted to the trailing moving object. Accordingly, the trailing moving object can acquire its own position using the trained model that is updated and the detection results of the mobility environment.

The present disclosure may be realized in various forms other than a learning device and a learning method. For example, the present disclosure can be realized in the form of a system, a vehicle, a server, a computer program, a recording medium in which the computer program is recorded, or the like.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an explanatory diagram illustrating a configuration of a system according to a first embodiment;

FIG. 2 is an explanatory diagram illustrating a configuration of a vehicle according to the first embodiment;

FIG. 3 is an explanatory diagram illustrating a configuration of a server according to the first embodiment;

FIG. 4 is a flowchart showing processing procedures for traveling control of the vehicle;

FIG. 5 is a flowchart showing procedures for trained model updating processing according to the first embodiment;

FIG. 6 is an explanatory diagram illustrating how the trained model updating processing of the first embodiment is executed;

FIG. 7 is an explanatory diagram illustrating a configuration of a system according to a second embodiment;

FIG. 8 is an explanatory diagram illustrating a configuration of a server according to the second embodiment;

FIG. 9 is a flowchart showing procedures of trained model updating processing according to the second embodiment; and

FIG. 10 is an explanatory diagram illustrating a configuration of a vehicle according to a third embodiment.

### DETAILED DESCRIPTION OF EMBODIMENTS

### A. First embodiment

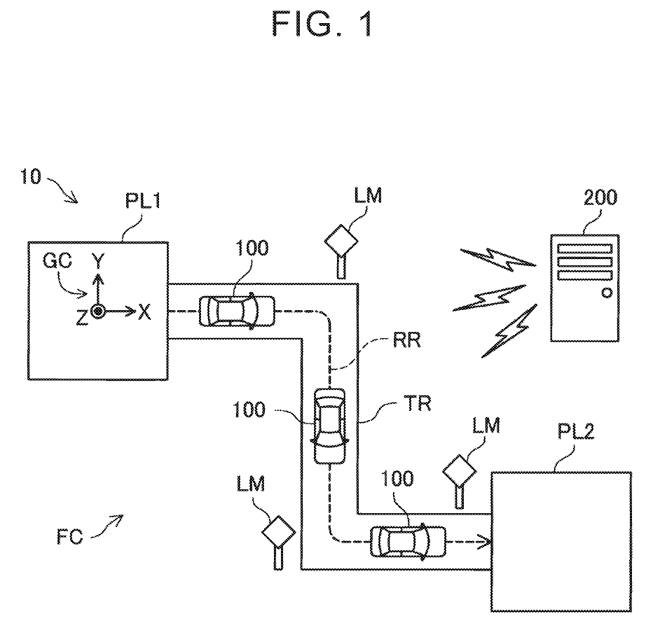

FIG. 1 is an explanatory diagram illustrating a configuration of a system 10 including a learning device according to a first embodiment. In the present embodiment, the system 10 includes a plurality of vehicles 100 and a server 200. Although three vehicles 100 are illustrated in FIG. 1, the number of vehicles 100 is not limited to three, and may be two, or may be four or more. Note that in the present embodiment, "vehicle 100" corresponds to "moving object" in the present disclosure, and "server 200" corresponds to "learning device" in the present disclosure.

In the present disclosure, "moving object" refers to an object that can move, such as a vehicle or an electric vertical take-off and landing aircraft (a so-called flying car), for example. The vehicle may be a vehicle that travels by wheels, or a vehicle that travels by continuous tracks, and may be, for example, a passenger car, a truck, a bus, a two-wheeled vehicle, a four-wheeled vehicle, a construction vehicle, or the like. Vehicles include battery electric vehicles, gasoline-powered vehicles, hybrid electric vehicles, and fuel cell electric vehicles. When the moving object is other than a vehicle, the expressions "vehicle" and "car" in this disclosure can be replaced with "moving object" as appropriate, and the expression "traveling" can be replaced with "moving" as appropriate.

The vehicle 100 is configured to be capable of traveling by unmanned driving. The term "unmanned driving" means driving without operations for traveling by an occupant. The term "operations for traveling" refers to operations related to at least one of "traveling", "turning", and "stopping" of the vehicle 100. Unmanned driving is realized by automatic or manual remote control using a device situated externally from the vehicle 100, or by autonomous control of the vehicle 100. The vehicle 100 traveling by unmanned driving may have an occupant on board who does not perform operations for traveling. Examples of occupants who do not perform operations for traveling include people who are simply sitting in seats of the vehicle 100, and people who are performing tasks other than operations for traveling, such as assembly, inspection, operating switches, or the like, while riding in the vehicle 100. Note that driving under operations for traveling being performed by an occupant may be referred to as "manned driving".

In the present specification, "remote control" includes "full remote control", in which all actions of the vehicle 100 are fully decided externally from the vehicle 100, and "partial remote control" in which part of the actions of the vehicle 100 are decided externally from the vehicle 100. Also, "autonomous control" includes "fully autonomous control" in which the vehicle 100 autonomously controls its own actions without receiving any information whatsoever from devices that are external from the vehicle 100, and "partially autonomous control" in which the vehicle 100 autonomously controls its own actions using information received from devices that are external from the vehicle 100.

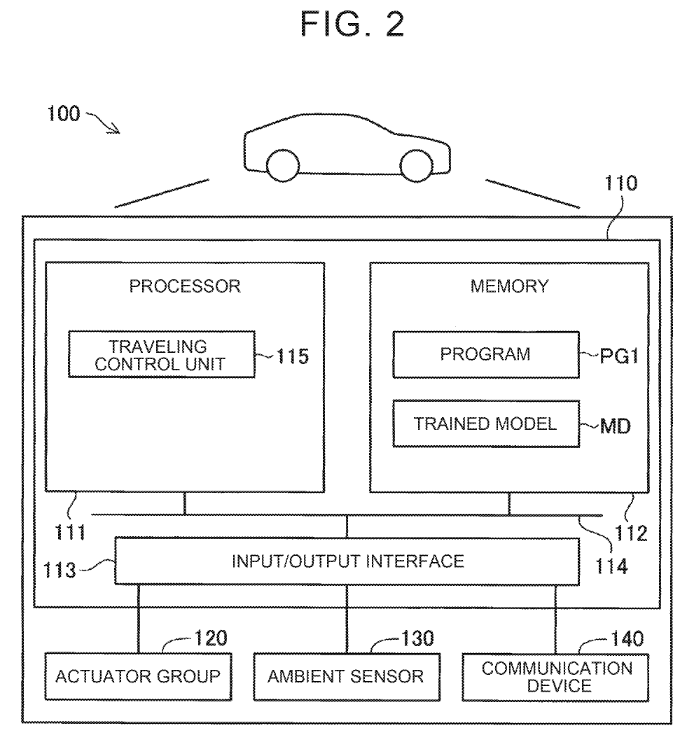

FIG. 2 is an explanatory diagram illustrating a configuration of the vehicle 100. In the present embodiment, the vehicle 100 is configured to be capable of traveling under autonomous control. The vehicle 100 includes a vehicle control device 110, an actuator group 120, an ambient sensor 130, and a communication device 140. The actuator group 120 includes at least one actuator. In the present embodiment, the actuator group 120 includes an actuator that is a drive device for generating propulsive force for the vehicle 100, an actuator that is a steering device for changing direction of travel of the vehicle 100, and an actuator that is a braking device for generating braking force for the vehicle 100. Each of the actuators included in the actuator group 120 is driven under control of the vehicle control device 110.

The ambient sensor 130 detects a traveling environment around the vehicle 100. In the present embodiment, the ambient sensor 130 is a camera that captures images of a traveling environment ahead of the vehicle 100. The ambient sensor 130 outputs images generated by capturing images of the traveling environment ahead of the vehicle 100, as traveling environment detection results. Note, however, that the ambient sensor 130 is not limited to a camera, and may be, for example, a LiDAR device. When the ambient sensor 130 is a LiDAR device, the ambient sensor 130 outputs a point cloud generated by scanning the traveling environment as traveling environment detection results.

The vehicle control device 110 controls each part of the vehicle 100. The vehicle control device 110 is made up of a computer including a processor 111, memory 112, an input/output interface 113, and an internal bus 114. The processor 111, the memory 112, and the input/output interface 113 are connected via the internal bus 114 so as to be able to communicate bidirectionally. The input/output interface 113 is connected to the actuator group 120, the ambient sensor 130, and the communication device 140. In the present embodiment, the communication device 140 communicates with the server 200 by wireless communication.

The processor 111 functions as a traveling control unit 115 by executing a computer program PG1 stored in advance in the memory 112. When an occupant is on board the vehicle 100, the traveling control unit 115 can cause the vehicle 100 to travel by controlling the actuator group 120 in accordance with the operation of the vehicle 100 by the occupant. The traveling control unit 115 can acquire position information of the vehicle 100 using detection results from the ambient sensor 130 and a trained model MD stored in the memory 112, regardless of whether there is an occupant on board the vehicle 100, and can cause the vehicle 100 to travel by autonomous control based on the position information of the vehicle 100. The trained model MD performs learning in advance using a training dataset that includes, for example, a plurality of images generated by capturing images of the traveling environment, and position information for points at which each of the images was captured. When an image that is the detection result of the ambient sensor 130 is input, the trained model MD outputs position information of the vehicle 100 equipped with the ambient sensor 130. In the following description, position information of the vehicle 100 will be referred to as "vehicle position information".

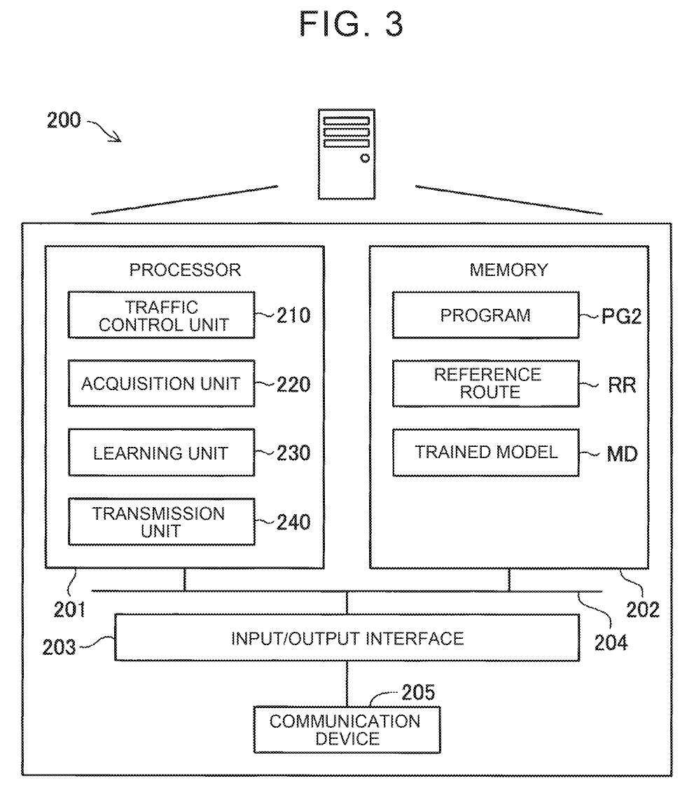

FIG. 3 is an explanatory diagram illustrating a configuration of the server 200. The server 200 is situated externally from the vehicle 100. The server 200 is made up of a computer including a processor 201, memory 202, an input/output interface 203, and an internal bus 204. The server 200 further includes a communication device 205 that communicates with the vehicle 100. The processor 201, the memory 202, and the input/output interface 203 are connected via the internal bus 204 so as to be able to communicate bidirectionally. The communication device 205 is connected to the input/output interface 203.

The processor 201 executes a computer program PG2 stored in the memory 202 in advance to function as a traffic control unit 210, an acquisition unit 220, a learning unit 230, and a transmission unit 240. The traffic control unit 210 decides the order in which the vehicles 100 will travel. The traffic control unit 210 transmits a travel permission signal, and a reference route RR that is stored in the memory 202 in advance, to the vehicles 100, in the order that is decided. The reference route RR indicates a route along which each of the vehicles 100 should travel. Routes are expressed by a node indicating a starting point, nodes indicating waypoints, a node indicating a destination, and links connecting the nodes. However, when the reference route RR is stored in advance in the memory 112 of the vehicle control device 110, the traffic control unit 210 does not need to transmit the reference route RR. Upon receiving the travel permission signal, the vehicle 100 starts traveling under autonomous control. The acquisition unit 220 acquires the detection results from the ambient sensor 130 installed in the vehicle 100. The learning unit 230 updates the trained model MD stored in the memory 202, using the detection results acquired by the acquisition unit 220. The transmission unit 240 transmits the trained model MD updated by the learning unit 230 to the vehicle 100.

As illustrated in FIG. 1, in the present embodiment, the system 10 is used to cause the vehicles 100 to travel under autonomous control in a factory FC where the vehicles 100 are being manufactured. The factory FC includes a first location PL1 and a second location PL2. The first location PL1 and the second location PL2 are connected by a track TR along which the vehicles 100 can travel. The first location PL1 is, for example, a location where assembly of the vehicles 100 is carried out. Once assembled at the first location PL1, the vehicles 100 are in a state of being capable of traveling under autonomous control. The vehicles 100 assembled at the first location PL1 move by traveling along the track TR, under autonomous control, to the second location PL2. The second location PL2 is, for example, a location where inspection of the vehicles 100 is carried out. Vehicles 100 that pass the inspection at second location PL2 are then shipped from the factory FC. At least one landmark LM is provided on the track TR or nearby the track TR, to allow the vehicle 100 to identify its own position. The landmarks LM include, for example, road markings painted on the surface of the track TR, and signs and buildings installed nearby the track TR. A reference coordinate system of the factory FC is a global coordinate system GC, and any position within the factory FC can be expressed by X, Y, Z coordinates in the global coordinate system GC.

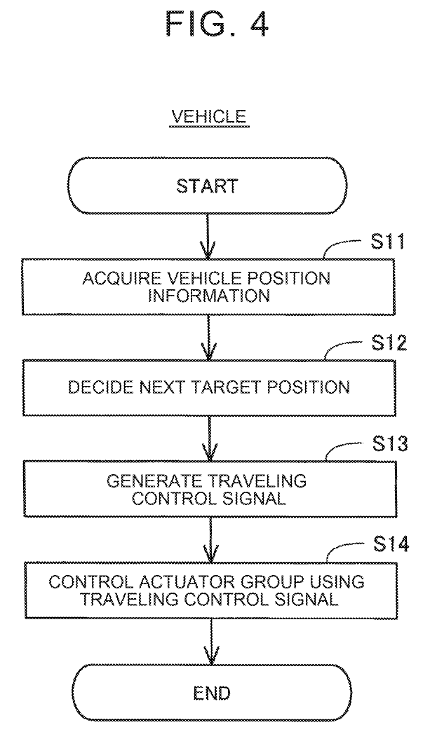

FIG. 4 is a flowchart showing processing procedures for traveling control of the vehicle 100. In step S11, the traveling control unit 115 acquires vehicle position information using detection results from the ambient sensor 130 and the trained model MD. The vehicle position information is the position information that is the basis for generating traveling control signals. In the present embodiment, the vehicle position information includes position and orientation of the vehicle 100 in the global coordinate system GC. In the present embodiment, the traveling control unit 115 captures images of the traveling environment using the camera that is the ambient sensor 130, and inputs the images obtained by capturing into the trained model MD. The trained model MD detects landmarks LM from out of the image and outputs vehicle position information estimated from the type, position, size, and so forth, of the landmarks LM.

In step S12, the traveling control unit 115 decides a target position to which the vehicle 100 should next head. In the present embodiment, the target position is expressed by X, Y, Z coordinates in the global coordinate system GC. The traveling control unit 115 uses the vehicle position information and the reference route RR received from the server 200 to decide the target position to which the vehicle 100 should next head. The traveling control unit 115 decides the target position on the reference route RR ahead of the current position of the vehicle 100.

In step S13, the traveling control unit 115 generates traveling control signals for causing the vehicle 100 to travel toward the target position that is decided. In the present embodiment, the traveling control signals includes acceleration and steering angle of the vehicle 100 as parameters. The traveling control unit 115 calculates traveling speed of the vehicle 100 from transition in the position of the vehicle 100, and compares the traveling speed that is calculated with a target speed. Overall, the traveling control unit 115 decides the acceleration such that the vehicle 100 accelerates when the traveling speed is lower than the target speed, and decides the acceleration such that the vehicle 100 decelerates when the traveling speed is higher than the target speed. Also, when the vehicle 100 is situated on the reference route RR, the traveling control unit 115 decides the steering angle and the acceleration such that the vehicle 100 does not deviate from the reference route RR, and when the vehicle 100 is not situated on the reference route RR, in other words, when the vehicle 100 has deviated from the reference route RR, decides the steering angle and the acceleration such that the vehicle 100 returns to the reference route RR. Note that in other embodiments, the travel control signal may include the speed of the vehicle 100 as a parameter, instead of the acceleration of the vehicle 100 or in addition to the acceleration.

In step S14, the traveling control unit 115 controls the actuator group 120 using the traveling control signals that are generated, thereby causing the vehicle 100 to travel at the acceleration and the steering angle indicated by the traveling control signals. The traveling control unit 115 repeats, at a predetermined cycle, acquiring vehicle position information, deciding a target position, generating traveling control signals, and controlling the actuator group 120.

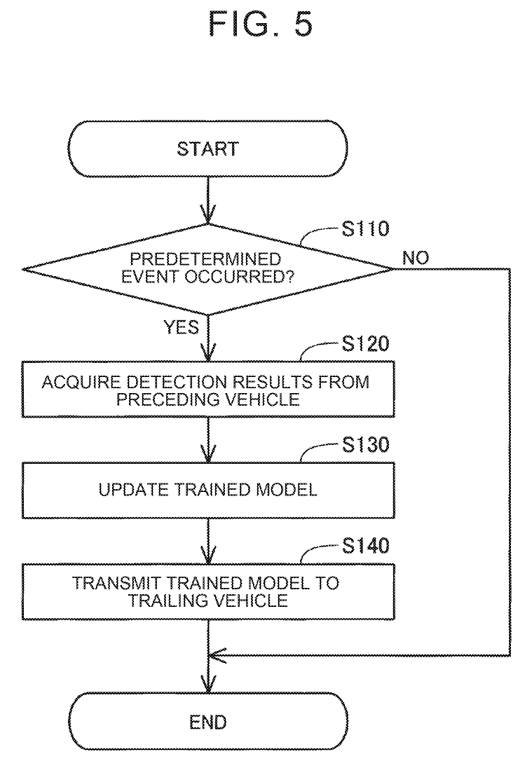

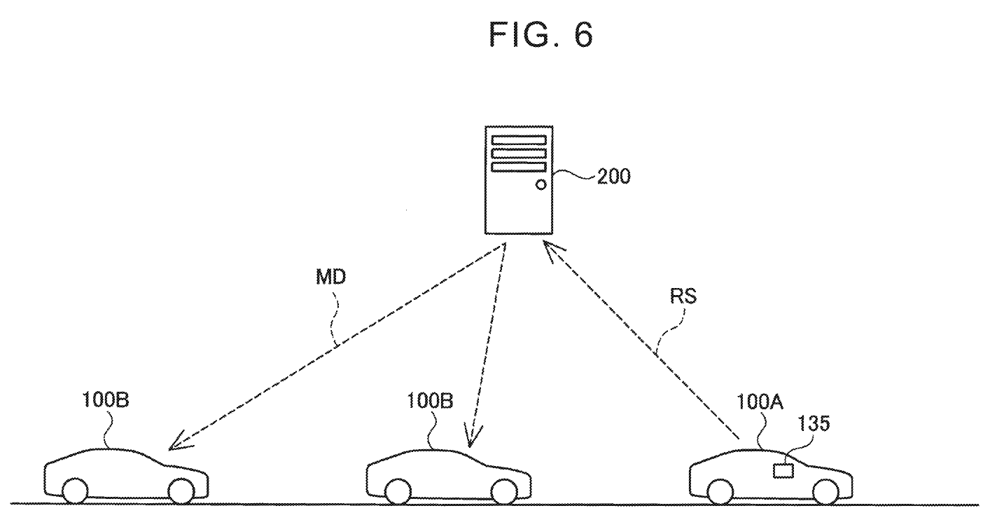

FIG. 5 is a flowchart showing procedures for trained model updating processing. FIG. 6 is an explanatory diagram illustrating how the trained model updating processing is executed. In the present embodiment, the trained model updating processing is repeatedly executed by the server 200 at a predetermined cycle.

As illustrated in FIG. 5, in step S110, the acquisition unit 220 of the server 200 determines whether a predetermined event has occurred. In the present embodiment, the predetermined event is construction work being carried out on the track TR or nearby the track TR. When construction work is carried out on the track TR or nearby the track TR, the traveling environment changes. Changes in the traveling environment include removal of the landmarks LM, change in position or orientation of the landmarks LM, change in the appearance of the landmarks LM, change of the landmarks LM to other landmarks, and the landmarks LM being hidden and no longer visible from the track TR. In these cases, the existing trained model MD may not be able to estimate the vehicle position information, or even when being able to estimate vehicle position information, accuracy of the vehicle position information may be reduced. The acquisition unit 220 can determine whether construction work is being carried out by using, for example, a surveillance camera (omitted from illustration) installed in the factory FC. The acquisition unit 220 may determine whether construction work is being carried out using construction information externally acquired via wired communication or wireless communication. The construction information may be transmitted to the server 200 by, for example, an administrator of the system 10 or a worker at the factory FC.

When determination is made in step S110 that the predetermined event is not occurring, the server 200 skips step S110 and subsequent steps, and terminates the trained model updating processing. Conversely, when determination is made in step S110 that the predetermined event has occurred, in step S120 the acquisition unit 220 of the server 200 acquires traveling environment detection results RS from a preceding vehicle 100A that has traveled on the track TR after the event occurred. The preceding vehicle 100A is a vehicle 100 that is traveling on the track TR ahead of trailing vehicles 100B. In the present embodiment, the preceding vehicle 100A is equipped with a GSNN (Global Navigation Satellite System) receiver 135 (see FIG. 6), and is configured to be able to acquire the vehicle position information using the GNSS receiver 135 without having to acquire the vehicle position information using the traveling environment detection results RS obtained from the ambient sensor 130 and the trained model MD. However, the preceding vehicle 100A may be provided with an inertial measurement unit instead of the GNSS receiver 135, and may be configured to acquire the vehicle position information using the inertial measurement unit. Alternatively, the preceding vehicle 100A may be equipped with the inertial measurement unit in addition to the GNSS receiver 135, and may be configured to acquire the vehicle position information using the GNSS receiver 135 and the inertial measurement unit. In the present embodiment, the traffic control unit 210 decides the traveling order of the vehicles 100 such that the preceding vehicle 100A among the vehicles 100 travels on the track TR first after an event occurs. When the traveling order of the plurality of vehicles 100 decided before the occurrence of an event is not the traveling order in which the preceding vehicle 100A among the plurality of vehicles 100 travels over the track TR first, the traffic control unit 210 changes the traveling order of the 100 after the occurrence of the event, such that the preceding vehicle 100A among the vehicles 100 travels over the track TR first.

In step S130, the learning unit 230 of the server 200 updates the trained model MD using the traveling environment detection results RS acquired from the preceding vehicle 100A. Updating the trained model MD includes relearning of the trained model MD, and additional learning of the trained model MD. The learning unit 230 updates the trained model MD by fine-tuning using a training dataset including, for example, a plurality of images of the traveling environment obtained from the preceding vehicle 100A, and vehicle position information corresponding to each of the images. The vehicle position information acquired using the GNSS receiver 135 can be used as the vehicle position information corresponding to each of the images.

In step S140, the transmission unit 240 of the server 200 transmits the updated trained model MD to the trailing vehicles 100B. The trailing vehicles 100B are vehicles 100 that are traveling on the track TR behind the preceding vehicle 100A. Thereafter, the server 200 ends the trained model updating processing. The trailing vehicles 100B that receive the trained model MD following updating, from the server 200, overwrite the trained model MD before updating, stored in the memory 112 of the vehicle control device 110 installed in the own vehicle, with the trained model MD that is updated. Now, the ambient sensor 130 of the preceding vehicle 100A is preferably configured to be able to detect the traveling environment in more detail than the ambient sensors 130 of the trailing vehicles 100B. Being able to detect the traveling environment in detail includes high resolution when the ambient sensor 130 is a camera, and high density of the point cloud when the ambient sensor 130 is a LiDAR device. When the ambient sensor 130 of the preceding vehicle 100A is configured to be able to detect the traveling environment in more detail than the ambient sensors 130 of the trailing vehicles 100B, precision of detecting the landmarks LM using the trained model MD that is updated can be improved.

According to the system 10 in the present embodiment described above, the server 200 updates the trained model MD using the traveling environment detection results RS obtained from the preceding vehicle 100A, and transmits the trained model MD that is updated to the trailing vehicles 100B. Accordingly, even when a change occurs in the traveling environment, the trailing vehicles 100B traveling behind the preceding vehicle 100A can acquired vehicle position information using the trained model MD that is updated and the traveling environment detection results RS obtained from the ambient sensor 130 installed in the own vehicle, and can travel to the destination under autonomous control.

Also, according to the present embodiment, when a predetermined event occurs in which the traveling environment changes, the server 200 updates the trained model MD using the traveling environment detection results RS obtained from the preceding vehicle 100A that traveled after the event occurred. This enables the trained model MD to be updated at an appropriate timing.

### B. Second embodiment

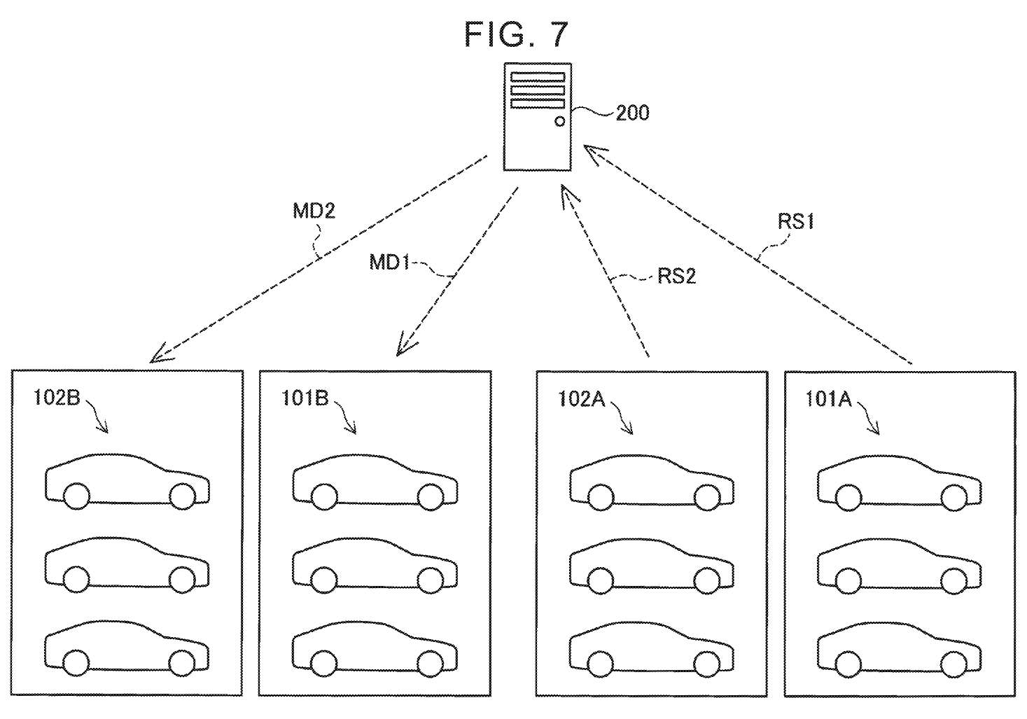

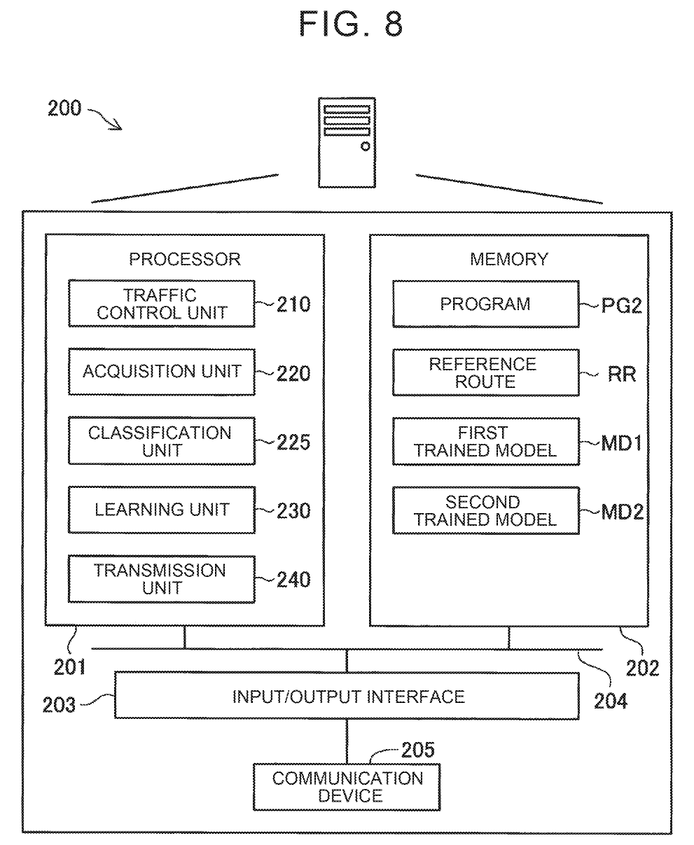

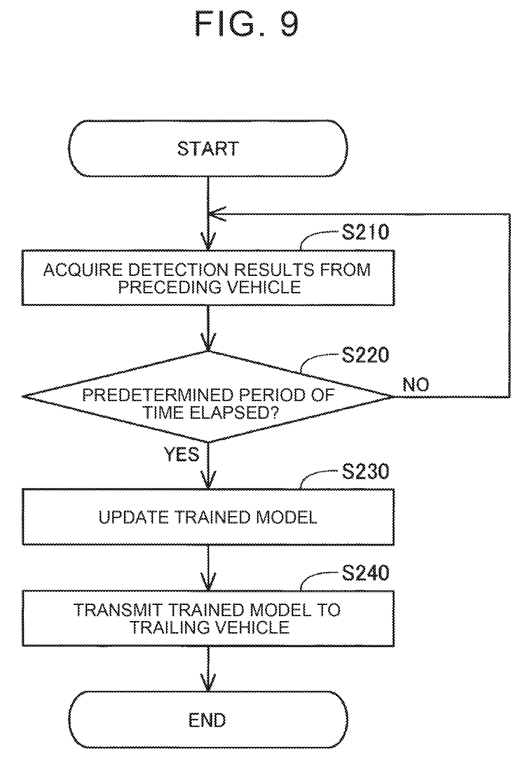

FIG. 7 is an explanatory diagram illustrating a configuration of the system 10 according to the second embodiment. FIG. 8 is an explanatory diagram illustrating the configuration of the server 200 in the second embodiment. FIG. 9 is a flowchart showing procedures of trained model updating processing in the second embodiment. The system 10 in the second embodiment differs from the first embodiment in that the server 200 includes a classification unit 225 and contents of the trained model updating processing are different. The other configurations are the same as those of the first embodiment unless otherwise described. Note that in the present embodiment, the server 200 corresponds to the learning device according to the present disclosure.

As illustrated in FIG. 7, according to the present embodiment, the vehicles 100 include a first-type vehicle 101 and a second-type vehicle 102. The first-type vehicle 101 and the second-type vehicle 102 are different vehicle models. The difference in vehicle models includes, for example, difference in type of the ambient sensor 130, difference in position of the ambient sensor 130, and difference in position estimation algorithm. In the present embodiment, the type of the ambient sensor 130 differs between the first-type vehicle 101 and the second-type vehicle 102. The first-type vehicle 101 is equipped with a camera for the ambient sensor 130. The ambient sensor 130 of the first-type vehicle 101 outputs images as traveling environment detection results RS. The second-type vehicle 102 is equipped with a LiDAR device for the ambient sensor 130. The ambient sensor 130 of the second-type vehicle 102 outputs point clouds as traveling environment detection results RS. In the following description, the detection results RS output from the ambient sensor 130 of the first-type vehicle 101 will be referred to as "first detection results RS1", and detection result RS output from the ambient sensor 130 of the second-type vehicle 102 will be referred to as "second detection result RS2". A first trained model MD1, which is the trained model MD for the first-type vehicle 101, outputs vehicle position information when the first detection results RS1 are input, and a second trained model MD2, which is the trained model MD for the second-type vehicle 102, outputs vehicle position information when the second detection results RS2 are input.

As illustrated in FIG. 8, in the present embodiment, the processor 201 of the server 200 functions as the traffic control unit 210, the acquisition unit 220, a classification unit 225, the learning unit 230, and the transmission unit 240, by executing the computer program PG2 stored in the memory 202 in advance. The acquisition unit 220 acquires the traveling environment detection results RS1, RS2 from each of the vehicles 100. The classification unit 225 classifies the detection results RS1, RS2 acquired from each of the vehicles 100 by vehicle model of each of the vehicles 100. The classification unit 225 classifies the detection results RS1, RS2 acquired from each of the vehicles 100 into the first detection results RS1 acquired from the first-type vehicles 101 and the second detection results RS2 acquired from the second-type vehicles 102. The learning unit 230 updates the first trained model MD1 using the first detection results RS1, and updates the second trained model MD2 using the second detection results RS2. The transmission unit 240 transmits the first trained model MD1 that is updated to the first-type vehicles 101 and transmits the second trained model MD2 that is updated to the second-type vehicles 102.

The trained model updating processing shown in FIG. 9 is repeatedly executed by the server 200 at predetermined cycles. In step S210, the acquisition unit 220 of the server 200 acquires the traveling environment detection results RS1, RS2 from each of the vehicles 100, and the classification unit 225 classifies the detection results RS1, RS2 acquired by the acquisition unit 220 according to the vehicle model and performs storage thereof in the memory 202.

In step S220, the learning unit 230 of the server 200 determines whether the predetermined period of time has elapsed. In the present embodiment, the predetermined period of time is one month. However, the predetermined period of time may be shorter than one month, or may be longer than one month. When determination is made in step S220 that the predetermined period of time has not elapsed, the server 200 returns the processing to step S210 and repeats the processing from step S210 to step S220 until determination is made in step S220 that the predetermined period of time has elapsed. In the following description, the first-type vehicle 101 that has traveled over the track TR within the above period of time will be referred to as "first-type preceding vehicle 101A", and the first-type vehicle 101 that travels over the track TR following the above period of time will be referred to as "first-type trailing vehicle 101B". The second-type vehicle 102 that has traveled over the track TR within the above period of time will be referred to as "second-type preceding vehicle 102A", and the second-type vehicle 102 that travels over the track TR following the above period of time will be referred to as "second-type trailing vehicle 102B".

When determination is made in step S220 that the predetermined period of time has elapsed, the learning unit 230 of the server 200 updates the first trained model MD1 using the first detection results RS1 acquired from the first-type preceding vehicle 101A in step S230, and updates the second trained model MD2 using the second detection results RS2 acquired from the second-type preceding vehicle 102A. In step S240, the transmission unit 240 of the server 200 transmits the first trained model MD1 that is updated to the first-type trailing vehicle 101B, and transmits the second trained model MD2 that is updated to the second-type trailing vehicle 102B. Thereafter, the server 200 ends the trained model updating processing.

According to the system 10 according to the present embodiment described above, when the predetermined period of time has elapsed, the server 200 updates the trained models MD1, MD2 using the detection results RS1, RS2 obtained from the preceding vehicles 101A, 102A that traveled within the period, and transmits the trained models MD1, MD2 that are updated, to the trailing vehicles 101B, 102B. Accordingly, when the traveling environment gradually changes, the precision of position estimation by the trained models MD1, MD2 can be suppressed from deteriorating.

Also, according to the present embodiment, the classification unit 225 of the server 200 classifies the detection results RS1, RS2 acquired from each of the vehicles 100, by vehicle model. Accordingly, the detection results RS1, RS2 that are classified can be used to update the trained models MD1, MD2 for each vehicle model.

### C. Third embodiment

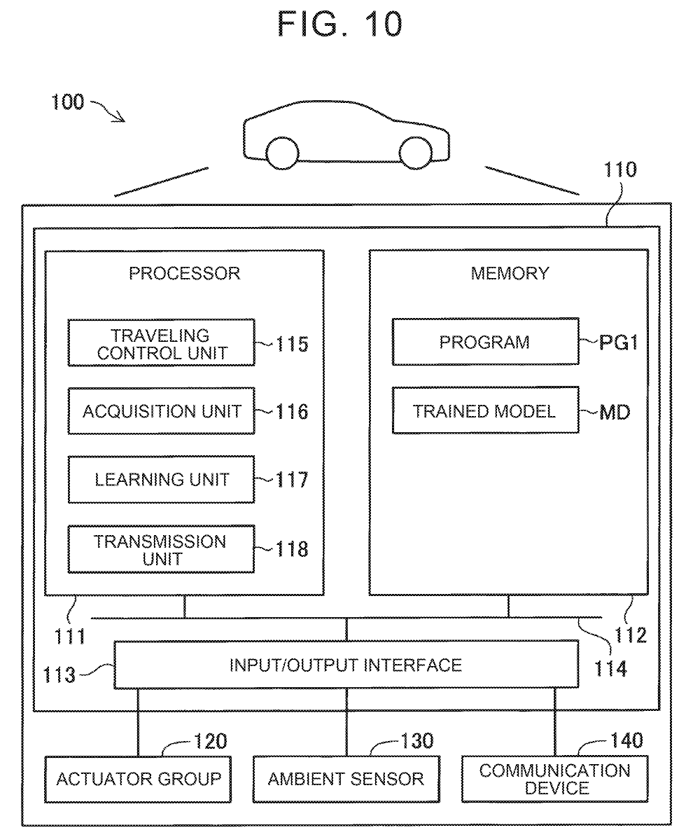

FIG. 10 is an explanatory diagram illustrating a configuration of the preceding vehicle 100A in the system 10 according to a third embodiment. The third embodiment differs from the first embodiment in that the updating of the trained model MD is executed at the preceding vehicle 100A rather than at the server 200. The other configurations are the same as those of the first embodiment unless otherwise described. Note that in the present embodiment, the vehicle control device 110 installed in the preceding vehicle 100A corresponds to the learning device in the present disclosure.

In the present embodiment, the preceding vehicle 100A can communicate with the trailing vehicles 100B by wireless communication, using the communication device 140. The processor 111 of the vehicle control device 110 installed in the preceding vehicle 100A functions as the traveling control unit 115, an acquisition unit 116, a learning unit 117, and a transmission unit 118, by executing the computer program PG1 stored in advance in the memory 112. The traveling control unit 115 can acquire vehicle position information of the own vehicle using the detection results of the ambient sensor 130 and the trained model MD stored in the memory 112, and can cause the own vehicle to travel based on the vehicle position information of the own vehicle. The acquisition unit 116 acquires the detection results from the ambient sensor 130 installed in the own vehicle. The learning unit 117 updates the trained model MD using the detection results acquired by the acquisition unit 116. The transmission unit 118 transmits the trained model MD updated by the learning unit 117 to the trailing vehicles 100B. The trailing vehicles 100B that receive the trained model MD following updating, from the preceding vehicle 100A, overwrite the trained model MD before updating, stored in the memory 112 of the vehicle control device 110 installed in the own vehicle, with the trained model MD that is updated. It should be noted that the trailing vehicles 100B do not necessarily have to include the acquisition unit 116, the learning unit 117, and the transmission unit 118.

According to the system 10 according to the present embodiment described above, the trained model MD can be updated at the preceding vehicle 100A and the learned model MD that is updated can be transmitted to the trailing vehicles 100B.

### D. Other Embodiments

(D1) In the first embodiment, the predetermined event may include, in addition to construction or instead of construction, at least one of change in weather at the factory location, and change in the position estimation algorithm due to a software update of the vehicle 100. In such cases, the existing trained model MD may not be able to acquire correct position information. The server 200 can detect changes in the weather using surveillance cameras installed in the factory FC or weather information acquired externally.

(D2) In the second embodiment, an arrangement may be made in which the vehicles 100 do not include one of the first-type vehicle 101 or the second-type vehicle 102. In this case, the server 200 does not need to include the classification unit 225.

(D3) In each of the above embodiments, it is sufficient for the vehicle 100 to be configured so as to be able to move by unmanned driving, and may be embodied as a platform having the configurations described below, for example. Specifically, it is sufficient for the vehicle 100 to include at least the vehicle control device 110, the actuator group 120, and the ambient sensor 130, in order to exhibit the three functions of "traveling", "turning", and "stopping", through unmanned driving. When the vehicle 100 is to externally acquire information for unmanned driving, the vehicle 100 may further include the communication device 140. That is to say, the vehicle 100 that can move by unmanned driving does not have to be equipped with at least some of the interior components such as the driver's seat, dashboard, and so forth, does not have to be equipped with at least some of the exterior components such as the bumpers, fenders, and so forth, and does not have to be equipped with a body shell. In this case, the remaining components, such as the body shell and so forth, may be attached to the vehicle 100 by the time at which the vehicle 100 is shipped from the factory FC, or the remaining parts such as the body shell and so forth may be attached to the vehicle 100 after the vehicle 100 is shipped from the factory FC in a state without the remaining parts such as the body shell and so forth being attached to the vehicle 100. Each of the components may be attached from any direction, such as upper side, lower side, front side, rear side, right side, or left side of the vehicle 100, and may each be attached from the same direction, or may each be attached from different directions.

(D4) The vehicle 100 may be manufactured by combining a plurality of modules. The term "module" refers to a unit made up of one or more components grouped together in accordance with the configuration and function of the vehicle 100. For example, the platform of the vehicle 100 may be manufactured by combining a front module that makes up a front part of the platform, a middle module that makes up a middle part of the platform, and a rear module that makes up a rear part of the platform. Note that the number of modules making up the platform is not limited to three, and may be two or less, or four or more. Also, in addition to or instead of the platform, portions of the vehicle 100 that are different from the platform may be modularized. The various types of modules may also include any exterior components such as bumpers and grilles, or any interior components such as seats and consoles. Also, moving objects of any form, not limited to the vehicle 100, may be manufactured by combining multiple modules. This sort of module may be manufactured by, for example, joining a plurality of components together by welding or by fasteners or the like, or may be manufactured by performing metallic casting of at least part of the module as one component, and performing integral molding therewith. The molding technique of integrally molding at least part of the modules as a single component is also referred to as gigacasting or megacasting. Using gigacasting enables each part of a moving object that was conventionally formed by joining a plurality of components to be formed as a single component. For example, the front module, the middle module, and the rear module may be manufactured using gigacasting.

(D5) Transporting of the vehicle 100 by traveling using unmanned driving of the vehicle 100 is called "self-propelled transport". The configuration for realizing self-propelled transport is also called "vehicle remote-controlled autonomous driving transport system." Also, a production method for producing the vehicle 100 using self-propelled transport is also referred to as "self-propelled production". In autonomous production, for example, at the factory FC where the vehicle 100 is manufactured, at least part of the transportation of the vehicle 100 is realized by self-propelled transport.

The present disclosure is not limited to the above-described embodiments, and can be realized in various configurations without departing from the spirit and scope thereof. For example, the technical features in the embodiments corresponding to the technical features in each aspect described in the Summary of the Disclosure section can be replaced or combined as appropriate in order to solve part or all of the above-described problems or to achieve part or all of the above-described advantages. Also, when a technical feature thereof is not described as being essential in the present specification, it can be omitted as appropriate.

What is claimed is:

1. A learning device comprising:
an acquisition unit that acquires a detection result of a mobility environment detected by a preceding moving object from among a plurality of moving objects that moves along a route that is set in advance;
a learning unit that updates a trained model using the detection result; and
a transmission unit that transmits the trained model that is updated to a trailing moving object, from among the moving objects, that moves along the route after the preceding moving object.

2. The learning device according to claim 1, wherein, when an event that is set in advance occurs, the learning unit updates the trained model using the detection result acquired from the preceding moving object that moved along the route after occurrence of the event.

3. The learning device according to claim 1, wherein, when a period of time that is set in advance elapses, the learning unit updates the trained model using the detection result acquired from the preceding moving object that moved along the route within the period of time.

4. The learning device according to claim 1, wherein the preceding moving object is configured to detect the mobility environment in more detail than the trailing moving object.

5. The learning device according to claim 1, wherein
the moving objects include a plurality of first-type moving objects and a plurality of second-type moving objects of a different type from the first-type moving objects,
the learning device further includes a classification unit that classifies a first detection result that is a detection result acquired from a first-type preceding moving object from among the first-type moving objects, and a second detection result that is a detection result acquired from a second-type preceding moving object from among the second-type moving objects,
the learning unit updates a first trained model using the first detection result, and updates a second trained model using the second detection result, and
the transmission unit transmits the first trained model that is updated to a first-type trailing moving object from among the first-type moving objects that move along the route after the first-type preceding moving object, and transmits the second trained model that is updated to a second-type trailing moving object from among the second-type moving objects that moves along the route after the second-type preceding moving object.

6. A learning method comprising:
acquiring a detection result of a mobility environment detected by a preceding moving object from among a plurality of moving objects that moves along a route that is set in advance;
updating a trained model using the detection result; and
transmitting the trained model that is updated to a trailing moving object, from among the moving objects, that move along the route after the preceding moving object.
